(19) United States
(12) Patent Application Publication
(10) Pub. No.: US 2022/0076325 A1
(43) Pub. Date: Mar. 10, 2022

(54) AN ONLINE COMMUNICATION SYSTEM

(71) Applicant: VICTORY SOFTWARE LIMITED, Auckland (NZ)

(72) Inventor: Lee-Ann GORDON, Auckland (NZ)

(73) Assignee: VICTORY SOFTWARE LIMITED, Auckland (NZ)

(21) Appl. No.: 17/424,487

(22) PCT Filed: Jan. 21, 2020
(86) PCT No.: PCT/NZ2020/050001

§ 371 Date: Jul. 20, 2021

(30) Foreign Application Priority Data
Jan. 21, 2019 (AU) 2019900174

(51) Int. Cl. G06Q 30/08; G06Q 30/06

(52) U.S. Cl. CPC G06Q 30/08; G06Q 30/0627; G06Q 30/0609

(57) ABSTRACT

In one aspect the invention provides a process carried out by an online system to provide a communication link between subscriber accounts to make transactions for items, the process comprising the steps of receiving from a first subscriber account item data carrying information on attributes of an item; storing item data carrying information on attributes on given items; and receiving from a second subscriber account search data carrying information on attributes of items sought, and running database queries dependent on the search data received to identify and return a list of items dependent on said attributes. The process further comprises a step of storing searching data subsequent to running a database query dependent on the search data, identifying a list of items returned by the database query, to transmitting for display the items returned by the database query, and to receiving control input from a subscriber linked to the search data indicating that the search data is valid so as to provide search data stored with a status of valid. The process further comprises a step of storing search data subsequent to running a database query dependent on the search data, identifying a list of items returned by the database query, to transmitting for display the items returned by the database query, and to receiving control input from a subscriber linked to the search data indicating that the search data is valid so as to provide search data stored with a data indicating validity. The process further comprises a step of storing search data subsequent to running a database query dependent on the search data, identifying a list of items returned by the database query, to transmitting for display the items returned by the database query, and to receiving control input from a subscriber linked to the search data indicating that the search data is valid so as to provide search data stored with a data indicating validity status of current.

### FIELD OF THE INVENTION

This invention relates to improvements in respect of systems for online transactions, such as system for online transactions between subscribers offering items and subscribers seeking items.

### BACKGROUND OF THE INVENTION

Online transaction systems typically provide databases of items to be transacted.

Typically, these online transaction systems allow subscribers to search for items they would like to buy, for example. Data carrying information of product attributes are stored on the database which generates queries from operator inputs to allow retrieval of items by searches conducted using their attributes.

Some online transaction systems allow a subscriber wanting to buy an item to communicate with another subscriber that has registered an item with the system. These systems provide a subscriber that registers an interest in buying an item to initiate communication with a party wanting to sell an item, in a one-way-initiated communication connection. These systems may receive data to register items to be sold by selling subscribers and subsequently support searches conducted by subscribers wanting to buy items and then subsequently provide a connection initiated by actions of a buying subscriber in response to a display of attributes of items to be sold.

Often these systems will need to support searches simultaneously for numerous subscribers searching for items to buy. A problem with this may be resourcing for searching and/or limited speed of searches.

Often online transaction systems will need to support communication between multiple subscribers registering an interest in buying a single given item that has been registered by another subscriber. A problem with this may be providing resources for these communication lines.

A related problem may be that multiple buyer inputs and communications may take time to resolve to the point of a transaction and the need for the system to provide resources for the related communications over this time.

Another problem may be that communications links initiated between a seller and one prospective buyer need to remain valid while a similar communication between another buyer and the same seller may be impacting on the validity of data represented in the other communication.

Another problem with online transaction systems is that the data used to identify items to be transacted may have limited validity. For example, an item registered in a database may be indicated to multiple buyer subscribers as available for purchase where one buying subscriber may have determined to buy it.

One conventional solution to problems related multiple concurrent lines of communication in respect of a seller and buyers of a given item is to impose processes to coordinate multiple buyer subscriber communications. A common system is an online bidding system. A problem with this system is resourcing the transaction process or communication links while the process is carried out. Data relating to subscriber interest in an item may be made available to multiple subscribers that have indicated an interest by any subscriber. A problem with this solution is limited control of the transaction by subscribers while bidding processes are carried out.

A particular challenge with online transaction systems resides in the computing resources required to store data for items to be sold.

Another challenge with online transaction systems resides in the computing resources required to support searching by subscribers through items stored.

Another challenge with online transaction systems is the speed of search queries supporting searching by subscribers through items stored.

Another challenge is in supporting communications between potentially multiple buyer subscribers and a seller subscriber.

Another challenge is in initiating communications between buyer subscribers and a seller subscriber.

A general challenge is the degree of control of the system and transaction related processes by subscriber operators.

It would therefore be of advantage to have an online transaction system which provides technical solutions addressing which could address any or all of the above technical problems and challenges, or at least provide the public with an alternative choice.

### DISCLOSURE OF THE INVENTION

Aspects of the invention provide a transaction system capable of storing search data which is validated before storage dependent on subscriber controls. For example, the transaction system may be able to store search data that validly indicates that an item is sought. For example also, the transaction system may be able to store search data that validly indicates that no item matching search data is already available on the system.

Aspects of the invention provide a transaction system capable of storing search data with further data carrying information on whether it is current. For example, the transaction system may be able to store search data that indicates a current indication that an item having defined attributes is sought. For example, the transaction system may be able to store search data that indicates a current indication that the search data was stored after items returned by a database query defined by the search data was displayed to the operator entering the search data.

Aspects of the invention provide a transaction system capable of storing search data with further data carrying information on the time and/or date when the search data was received and/or adjusted. For example, the transaction system may be able to store search data that indicates when the data was sought.

Aspects of the invention may provide a system which allow queries to be run on a number of external transactions systems and/or data base systems dependent on search data and/or item data received by subscriber accounts of the online transaction system.

Aspects of the invention provide a transaction system capable of storing search data with further data carrying information on whether it is current. For example, the transaction system may be able to store search data that indicates a current indication that an item is sought by a subscriber that has been validated. For example, search data may be validated as having been entered via a subscription which was initiated with payment and/or contact details of an operator or business associated with a subscriber. For example search data may be validates as having been entered via a subscription which was initiated by a defined process. The validation of search data may indicate to sellers of items subscribers that have a higher probability of completing a transaction or may be likely to enter a transaction with reduced transaction overhead or processing overhead. Subscribers associated with validated search data may be given earlier contact with subscribers that are offering items matching search criteria. This may further reduce processing of data storage overhead of for the transaction system.

In one aspect the invention provides a process carried out by a software system to provide a communication link between subscriber accounts to allow the accounts to make transactions for items, the process comprising the steps of:

receiving from a first subscriber account item data carrying information on attributes of an item offered for transaction;

running a first database query uses a search string generated dependent on said item data, wherein the search is run on a database which stores instances of search data carrying information on attributes of a respective item sought for transaction by other subscriber accounts,

displaying the results of the database query at the first subscriber account to allow an operator of the first subscriber account to view any instances of search data returned by the data base query,

receiving a control input from the first subscriber indicating that the item data is validated in response to an operator viewing the results of the database query to allow an operator of the first subscriber account to validate the item data; and

storing the item data with an indication of validation.

The first database query may be run in response to item data being received.

The process may comprise a step of initiating a communication link between a first subscriber account having entered item data used to generate the database query and a second subscriber account having entered search data returned in the database query.

Validation may be an indication that the item data is valid, for use in database queries run dependent on search data, as not having matching search data entered at another subscriber account that the first subscriber account will engage in a transaction for a corresponding item.

The step of storing item data with an indication of validity may be subsequent to said initiation of communication between a first subscriber and a second subscriber account so that the indication validity indicates the data is stored after the first subscriber has had an opportunity to communicate with any second subscriber having entered search data returned by the database query.

The communication link may carry bid data entered by the second subscriber wherein the bid data carries information on a bid made by the second subscriber for a transaction.

The bid data may be included in search data received to allow the bid data to be transmitted in response to any item data being returned by the database query.

The process may comprise a step of running a second database query on stored item data stored with an indication of validity, the second database query using a string generated dependent on search data received, transmitting the item data returned for display via a subscriber by which the search data was entered, and receiving a control input from a subscriber linked to the search data indicating that the search data received is validated.

The process may comprise a step of storing search data with an indication of validity subsequent to running the second database query and subsequent to receiving control input from the second so as to provide stored, validated search data.

Another broad aspect of the invention provides an online system operable to provide a communication link between subscriber accounts to make transactions for items:

the system operable to receive from a first subscriber account item data carrying information on attributes of an item;

the system operable to store item data carrying information on attributes on given items; and

the system operable to receive from a second subscriber account search data carrying information on attributes of items sought, and

the system further operable to run database queries dependent on the search data received to identify and return a list of items dependent on said attributes; and

the system operable to transmit for display at the first subscriber account transaction-communication data carrying information to be communicated from the second subscriber account to the first subscriber account.

The transaction-communication data may carry bid data which indicates a price which the second subscriber is offering to pay in a transaction for an item indicated by item data.

The bid data may be included in search data received to allow the bid data to be transmitted in response to any item data being returned by the database query.

The system may be further operable to store search data subsequent to running a database query dependent on the search data, identifying a list of items returned by the database query, to transmitting for display the items returned by the database query, and to receiving control input from a subscriber linked to the search data indicating that the search data is valid so as to provide search data stored with a status of valid.

The system may be further operable to store search data subsequent to running a database query dependent on the search data, identifying a list of items returned by the database query, to transmitting for display the items returned by the database query, and to a receiving control input from a subscriber linked to the search data indicating that the search data is valid so as to provide search data stored with data received by the control input indicating how recent the search data was entered.

In one aspect the invention provides an online system operable to provide a communication link between subscriber accounts to make transactions for items:

the system operable to receive from a first subscriber account item data carrying information on attributes of an item;

the system operable to store item data carrying information on attributes on given items; and

the system operable to receive from a second subscriber account search data carrying information on attributes of items sought, and

the system further operable to run database queries dependent on the search data received to identify and return a list of items dependent on said attributes.

The system may be operable to display to the first subscriber account transaction-communication data carrying information to be communicated from the second subscriber account to the first subscriber account.

The transaction-communication data may be bid data which indicates a price which the seeking subscriber is offering to pay in a transaction for an item indicated by item data.

Subsequent to displaying transaction-communication storing item listing data carrying an indication that one of more given item is offered for transaction.

Storing item listing data carrying an indication that one of more given item is offered for transaction may be subsequent to a step of receiving a control input from the first subscriber indicating that the one or more given items should be offered for transaction.

The transaction-communication data may be bid data which indicates a price which the seeking subscriber is offering to pay in a transaction for an item indicated by item data.

The system may be further operable to run a database query for instances of search data the query being dependent on item data received. This may provide a list of instances of search data which indicates specified attributes of items sought. This may identify subscribers entering data and/or control inputs indicating that they seek items with given attributes. This may provide a subscriber offering items to be connected with subscribers seeking items with the same or similar attributes to the item data being entered. This may identify a requirement for a communication link between given subscribers that are seeking items and given subscribers that are offering items. The requirement may be stored as data indicating that a communication link between given subscribers should be initiated.

The system may be operable to initiate a communication link between a subscriber account by which any of the item data returned in the results of said search were received and a subscriber account by which the search data was received.

The communication link may be initiated dependent on a control input indicating item data returned by the query. The search data may indicate attributes of an item offered via a subscriber account.

This may allow a user of a subscriber account used to offer an item to initiate communication with a user of a subscriber account seeking an item. This communication may be initiated prior to the system storing item data indicating that an item is offered for transaction. Data associated with the item data may be stored to indicate that a communication link has been initiated.

The system may be operable to display to an offering subscriber transaction-communication data carrying information which a seeking intends to be communicated to the offering subscriber. The transaction-communication data may be bid data which indicates a price which the seeking subscriber is offering to pay in a transaction for an item indicated by item data.

The system may be operable to initiate a communication link between a subscriber account by which any of the item data returned in the results of said search were received and a subscriber account by which the search data was received.

This communication link may be initiated prior to the system storing item data with an indication that an item is offered for transaction. The storing item data may be after an opportunity for a bidding process between the first subscriber providing item data and one of more second subscribers entering search data. This may allow only items not sold by the bidding process to be offered for sale on a listing on the online system. This may allow second subscribers entering search data an opportunity to bid on items earlier than the items being listed as offered for transaction.

The system may be operable to store search data received subsequent to running a database query dependent on the search data, to identify a list of items returned by the database query, to transmit for display the items returned by the database query, and to receiving control input from a subscriber linked to the search data indicating that the search data is valid so as to provide search data stored with a status of valid. The stored search data may be stored for use in generating queries for item data. The stored search data may be stored for use in generating queries for item data, and the system may be operable to run database queries for item data dependent on the search data, wherein said database query is run in response to item data being received by the transaction system.

The system may be operable to store search data received subsequent to running a database query dependent on the search data, identifying a list of items returned by the database query, to transmitting for display the items returned by the database query, and to receiving control input from a subscriber linked to the search data indicating that the search data is valid so as to provide search data stored with a data indicating validity.

The system may be operable to store search data received subsequent to running a database query dependent on the search data, identifying a list of items returned by the database query, to transmitting for display the items returned by the database query, and to receiving control input from a subscriber linked to the search data indicating that the search data is valid so as to provide search data stored with validity data indicating validity with a status of current.

The system may be operable to store search data received subsequent to running a database query dependent on the search data, identifying a list of items returned by the database query, to transmitting for display the items returned by the database query, and to receiving control input from a subscriber linked to the search data indicating that the search data is valid so as to provide search data stored with data indicating how recent the search data was entered.

This provides a transaction system wherein valid search data is available to run automated database queries for items matching a search.

The transaction system may be further operable to run one or more database queries for stored search data, the queries being generated dependent on received item data.

The system may be operable to display instances of search data to a subscriber entering item data and store the item data subsequent to receiving a control input of said subscriber indicating that the item does not correspond to a stored search. The stored item data may be stored as validated for listing on an online transaction system. This may allow validation of item data. This may allow item data which is stored to be indicated as validated. This may allow data indicating validation to be time-stamped.

The item data may be stored by the online transaction system as validated item data. ‘Validated’ may indicate that the item data should be posted to a public online interface provided by the transaction system. ‘Validated’ may indicate that the item data should be posted to a public online interface external to the transaction system.

‘Validated’ may indicate that the subscriber has posted the item data after the system has presented relevant search data and to the subscriber has interacted with the GUI to indicate that the item data should be posted. The reader may recognise this indication as a validation control by the subscriber.

The system may be operable to initiate a communication link between the offering subscriber entering the item data and one or more seeking subscribers having entered one or more instance of search data presented to the offering subscriber, wherein the communication link is initiated prior to posting. This allows seeking subscribers of validated search data to communicate with the offering subscriber before the item is stored as validated and posted publicly, for example.

The communication link may be operable to provide a transaction process allowing a transaction of the item prior to the item being posted. This may provide seeking subscribers an opportunity to buy an item before it is posted. This may allow an offering subscriber an opportunity to sell the item to motivated seeking subscribers prior to posting the item to a broader population of subscribers, such as a population that has not validated their search data or has not validated their subscription.

The system may be operable to display search data to a subscriber entering item data and store the item data in a storage repository used to publicly display item data, said storage of item data and public display being subsequent to receiving a control input of said subscriber indicating that the item does not correspond to a stored search. This may allow validation of item data. This may allow item data which is stored to be indicated as validated. This may allow data indicating validation to be time stamped.

The system may be operable to display to an offering subscriber transaction-communication data carrying information which a seeking intends to be communicated to the offering subscriber. The transaction-communication data may be bid data which indicates a price which the seeking subscriber is offering to pay in a transaction for an item indicated by item data.

The system may be operable to display instances of search data to a subscriber entering item data and store the item data subsequent to receiving a control input of said subscriber indicating that the item is validated for listing on an online transaction system.

The system may present transaction-communication data to the subscriber entering the item data, wherein said presentation may be prior to listing the item data on an online transaction system.

The system may be further operable to run a database query for instances of search data the query being dependent on item data received. This may provide a list of instances of search data which indicates specified attributes of items sought. This may identify subscribers entering data and/or control inputs indicating that they seek items with given attributes. This may provide a subscriber offering items to be connected with subscribers seeking items with the same or similar attributes to the item data being entered. This may identify a requirement for a communication link between given subscribers that are seeking items and given subscribers that are offering items. The requirement may be stored as data indicating that a communication link between given subscribers should be initiated.

The system may be operable to initiate a communication link between a subscriber account by which any of the item data returned in the results of said search were received and a subscriber account by which the search data was received.

This communication link may be initiated prior to the system storing item data carrying an indication that an item is offered for transaction.

The communication link may be initiated dependent on a control input indicating item data returned by the query. The search data may indicate attributes of an item offered via a subscriber account.

This may allow a user of a subscriber account used to offer an item to initiate communication with a user of a subscriber account seeking an item. This communication may be initiated prior to the system storing item data indicating that an item is offered for transaction. Data associated with the item data may be stored to indicate that a communication link has been initiated. This may allow a communication link to be established with subscribers offering items and subscribers seeking items before items are publicly posted. This may allow subscribers seeking items to discover items matching their search data before the items are publicly offered for sale.

The system may use the control inputs of subscribers to provide improved speed of database queries.

The system may use the control inputs of subscribers to allow reduced database resources for database queries.

The system may use the control inputs of subscribers to provide improved speed and/or allow reduced resources for storage operations.

These may be by running given database queries only through validated item data and/or search data. For example, database queries may be run to establish communication links for bidding only between subscribers which have previously validated that a given item is not previously sought and between subscribers that have previously validated that the search data has not been previously offered.

The system may generate a communication transmission to a subscriber account used to enter item data dependent on a search queries run prior to storing search data.

The system may generate a communication transmission to a subscriber account used to enter item data dependent on a search queries run dependent on stored search data.

The system may generate a communication transmission to a subscriber account used to enter item data the communication being dependent on a database query run dependent on stored search data. The database query may be dependent also on a schedule. The schedule may allow updated validation of item data.

The system may be operable to store search data, wherein the system is operable to run a query for stored search data dependent on received item data and to display results of said query and then to store the item data a) subsequent to displaying the results of the query using the subscriber account by which item data was received and b) dependent on receiving control data from the subscriber account indicating that the subscriber entering the item data has validated the item data in response to viewing the results of said query.

The system may be operable to initiate a communication link between a seeking subscriber account by which any of the search data returned in the results of said search was received by the system and an offering subscriber account by which the item data was received. The communication link may be initiated dependent on a control input indicating an instance of search data returned by the query. The search data may carry information indicating attributes of an item which is sought via a subscriber account.

This may allow a user of a subscriber account seeking an item to initiate communicate with a user of a subscriber account offering an item. This communication may be initiated prior to the system storing search data indicating attributes of an item is sough for transaction.

Data associated with search data may be stored to indicate that a communication link has been initiated.

The system may be operable to instantiate a data structure for search data received.

The system may be operable to instantiate a data structure for item data received.

The queries run by the system dependent on receiving search data may be run using the data structure.

The data structure may define relationships between attributes of the search data.

The data structure may define a hierarchy of attributes.

The data structure may define a rank of attributes.

The queries run by the system dependent on receiving search data may be run also dependent on a set of stored rules.

The stored rules may define criteria for including items in results of a query.

The stored rules may define data cleansing conditions.

The stored rules may define data validation conditions.

The rules may define a hierarchy of attributes used to run a database query.

The query may be a compound query comprised of multiple queries and the rules may define an order for running the multiple queries.

The rules may define parsing from the data structure to query commands.

The system may be operable to parse the search data dependent of a set of stored query rules defining query parameters of one or more additional databases.

The one or more additional databases may be external to the online transaction system.

The query rules may define query parameters required to run queries on data bases of one or more external systems. This may allow queries to be run on a number of external transactions systems and/or data base systems dependent on item data and/or search data received by subscriber accounts of the online transaction system.

The system may be operable to parse the item data dependent of a set of stored query rules defining query parameters of one or more additional databases. The query rules may define query parameters required to run queries on data bases of one or more external systems.

The system may be operable to parse the data structure of the system to a data structure used by a given other system.

The system may be operable to parse query parameters of one or more additional databases to query parameters or search data for running queries on the database of the system the parsing being dependent of a second set of set of stored query rules applied to query parameters of the one or more additional databases. This may allow item data and/or search data entered at the one or more additional databases to define database queries of item data dependent of search data, the queries running on the system. This may allow the system to provide a service for other databases, wherein the service identifies connections between subscribers of the one or more other database offering items and seeking items.

In another broad aspect the invention provides a process carried out by an online system to provide a communication link between subscriber accounts to make transactions for items, the process comprising the steps of:

receiving from a first subscriber item data carrying information on attributes of an item;

running a first database query dependent on the item data, the database query searching stored search data received from one of more second subscribers and carrying information on attributes of items sought by the one or more second subscribers, wherein the database query returns a list of instances of search data;

storing the received item data with an indication of validity subsequent to displaying the instances of search data returned by the query for stored search data at the first subscriber, wherein said storing of received item data is dependent on receiving control data from the first subscriber account indicating that the item data is validated in response to a viewing by an operator of the instances of search data returned by the query.

The database query may be run in response to item data being received.

The process may comprise receiving control inputs.

The process may comprise a step of initiating communication between a first subscriber and a second subscriber account.

The process may comprise a step of storing item data indicating that an item is offered for transaction said step being subsequent to initiation of communication between a first subscriber and a second subscriber account.

The process may comprise running a second database query on stored item data dependent on the search data received from a second subscriber, transmitting for display the item data returned by the database query, and to receiving control input from a subscriber linked to the search data indicating that the search data is validated.

The process may further comprise storing validated search data subsequent to running the second database query and receiving control input from the second so as to provide stored, validated search data.

The process may further comprise initiating a communication link between a subscriber account by which any of the item data returned in the results of said search were received and a subscriber account by which the search data was received.

The communication link may be initiated dependent on a control input indicating item data returned by the query.

The search data may indicate attributes of an item offered via a subscriber account.

This may allow a user of the first subscriber account, used to offer an item, to initiate communication with a user of the second subscriber account seeking an item.

In another broad aspect the invention provides a process carried out by an online system to provide a communication link between subscriber accounts to make transactions for items, the process comprising the steps of:

receiving from a first subscriber account item data carrying information on attributes of an item;

storing item data carrying information on attributes on given items; and

receiving from a second subscriber account search data carrying information on attributes of items sought, and

running database queries dependent on the search data received to identify and return a list of items dependent on said attributes.

The process may further comprise storing searching data subsequent to running a database query dependent on the search data, to identifying a list of items returned by the database query, to transmitting for display the items returned by the database query, and to receiving control input from a subscriber linked to the search data indicating that the search data is valid so as to provide search data stored with a status of valid.

The process may further comprise storing search data subsequent to running a database query dependent on the search data, identifying a list of items returned by the database query, to transmitting for display the items returned by the database query, and to receiving control input from a subscriber linked to the search data indicating that the search data is valid so as to provide search data stored with a data indicating validity.

The process may further comprise storing search data subsequent to running a database query dependent on the search data, identifying a list of items returned by the database query, to transmitting for display the items returned by the database query, and to receiving control input from a subscriber linked to the search data indicating that the search data is valid so as to provide search data stored with a data indicating validity status of current.

The process may further comprise storing search data subsequent to running a database query dependent on the search data, identifying a list of items returned by the database query, to transmitting for display the items returned by the database query, and to receiving control input from a subscriber linked to the search data indicating that the search data is valid so as to provide search data stored with data indicating how recent the search data was entered.

The process may further comprise running a database query for instances of search data the query being dependent on item data received. This may provide a list of instances of search data which indicates specified attributes of items sought. This may identify subscribers entering data and/or control inputs indicating that they seek items with given attributes. This may provide a subscriber offering items with an opportunity to be connected with subscribers seeking items with the same or similar attributes to the item data being entered. This may identify a requirement for a communication link between given subscribers that are seeking items and given subscribers that are offering items.

The subscriber entering the item data may be displayed the results of the query using a query string generated dependent on item data, or a subset of that item data.

The subscriber that entered the item details is able to interact with the GUI to indicate whether a communication link should be established with a subscriber having entered search data.

The requirement may be stored as data indicating that a communication link between given subscribers should be initiated.

The process may further comprise initiating a communication link between a subscriber account by which any of the item data returned in the results of said search were received and a subscriber account by which the search data was received.

The communication link may be initiated dependent on a control input indicating item data returned by the query. The search data may indicate attributes of an item offered via a subscriber account.

This may allow a user of a subscriber account used to offer an item to initiate communication with a user of a subscriber account seeking an item.

This process may subsequently to the communication link being initiated store validated item data carrying an indication that an item is offered for transaction on an online transaction system. The display may be public. The display may be available for browsing. The display may be an online transaction listing.

Data associated with the item data may be stored to indicate that a communication link has been initiated.

The process may further comprise a step of displaying to an offering subscriber transaction-communication data carrying information which a seeking intends to be communicated to the offering subscriber. The transaction-communication data may be bid data which indicates a price which the seeking subscriber is offering to pay in a transaction for an item indicated by item data.

The process may further comprise initiating a communication link between a subscriber account by which any of the item data returned in the results of said search were received and a subscriber account by which the search data was received.

The process may comprise running a query for stored search data dependent on received item data storing the item data a) subsequent to displaying the results of the query using the subscriber account by which item data was received and b) dependent on receiving control data from the subscriber account indicating that the subscriber entering the item data has validated the item data in response to viewing the results of said query.

As used herein the term ‘offering subscriber’ refers to a subscriber entering item data.

As used herein the term ‘seeking subscriber’ refers to a subscriber entering the search data.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 shows an online transaction system according to an embodiment of the invention;

FIG. 2 shows the online transaction system of FIG. 1 with additional functionality;

FIG. 3 shows an implementation of an online transaction system according to an additional embodiment of the invention;

FIG. 4 shows a part of use case process of a further embodiment of the invention;

FIG. 5 shows another part of the use case process of the embodiment of FIG. 4;

FIG. 6 shows another part of the use case process of the embodiment of FIG. 4 and FIG. 5;

FIG. 7 shows another part of the use case process of the embodiment of FIG. 4 and FIG. 5;

FIG. 8 shows another part of the use case process of the embodiment of FIGS. 4 to 7; and

FIG. 9 shows another part of the use case process of the embodiment of FIGS. 4 to 8.

Further aspects of the invention will become apparent from the following description of the invention which is given by way of example only of particular embodiments.

### BEST MODES FOR CARRYING OUT THE INVENTION

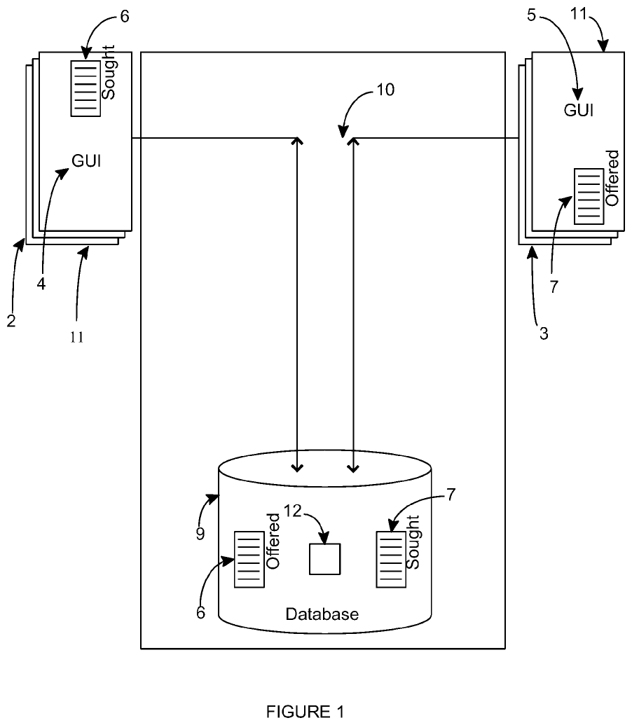

FIG. 1 shows an online transaction system 1 for online transactions between subscribers. FIG. 1 shows subscribers 2 and 3 interacting with the online transaction system 1 at graphical user interfaces (GUIs) 4 and 5. The subscribers are able to enter search data 6 which carries information on attributes of an item a subscriber is seeking for a transaction. Subscribers are also able to interact with the transaction system enter item data 7 which carries information on attributes of an item a subscriber is seeking for a transaction.

The system 1 communicates with a database 9 to store search data 6 and item data 7.

The system is able to initiate a communication link 10 between two or more subscribers 2 and 3 dependent on their interactions with the system. More specifically, the system 1 is able to initiate a communication link 10 between each of two or more subscribers 2 and 3 identified from a population of subscribers 11 by their interactions involving search data 6 and item data 7.

In this example a communication link 10 between a subscriber 2 that is seeking an item and a subscriber 3 that is offering an item where the subscriber and the communication link 10 is in the form of data 12 associated with the item data 12 of a specific item.

In this example a communication link 10 is initiated by the system 1 using search data 6 received to a database query to find items with attributes indicated in the search data 6 and initiating a communication link 10 with a subscriber 3 that is associated with the item returned by the query and then selected by the subscriber 2.

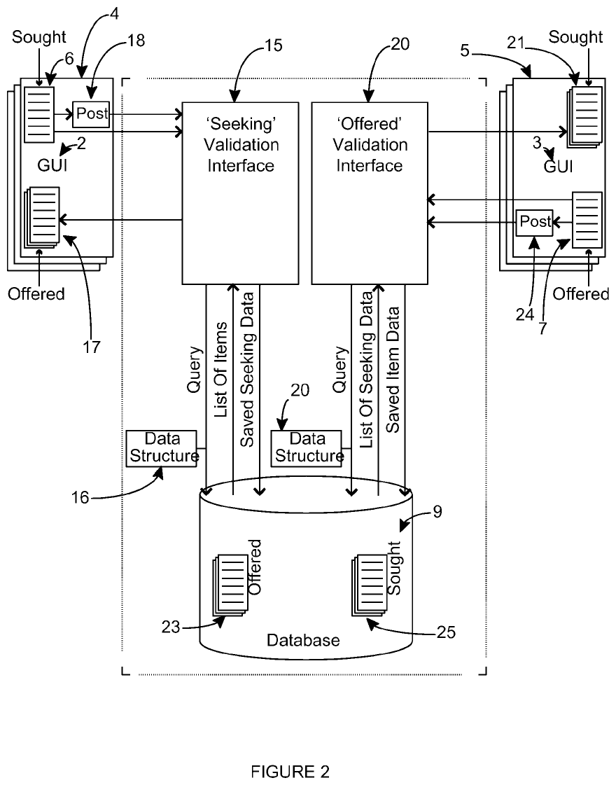

FIG. 2 shows the online transaction system 1 of the embodiment of FIG. 1 to illustrate additional functionality. FIG. 2 shows the system 1 having functionality to receive and validate search data 6 for items sought for transactions and/or item data 7 for items offered for transaction.

FIG. 2 shows the online transaction system 1 having a search-validation interface 15 which is able to receive uploaded non-validated search data 6. The search-validation interface 15 uses a data structure 16 to parse a database query for the database 9 which hold previously stored, or posted, item data 8. The database 9, running the query, returns a set or list 17 of instances of item data 7 which, in this specific example, are ranked and shortlisted before the list 17 is downloaded to the GUI 4 of the subscriber 2 that uploaded non-validated search data 7. The GUI 4 is able to display the instances of item data 17 to allow the subscriber 2 to select an item to initiate a communication link 10. The GUI 4 is also able to an input at control 18 that the search data 6 is valid in view of the set of item data 17 displayed at the GUI 4 and that the search data 6 should be stored in the database 9 as validated search data 23. The stored validated search data 23 is available to database queries and termed ‘posted’ on the online transaction system.

FIG. 2 shows the online transaction system 1 having an item validation interface 19 which is able to receive uploaded item data 7. The item validation interface 19 uses a data structure 20 to parse a database query to the database 9 which holds previously validated search data 7. The database 9, running the query, returns a set 21 of instances of search data 6 which, in this specific example, are ranked and may be shortlisted before the listed downloaded to the GUI 5 of the subscriber 3 that entered the non-validated item data 7. The GUI 5 is able to display a set 21 of instances of search data. The GUI 5 is also able to receive selection inputs to allow the subscriber 3 to select a search item to indicate that the system 1 should initiate a communication link 10. The GUI 5 is also able to receive a control input at control 24 to allow the subscriber 3 to indicate validity of the item data 7. The validated item data 25 data is then available to queries run by the database 9.

As illustrated by FIG. 2, the database 9 is able to store sets of validated search data 23 and sets of validated item data 25.

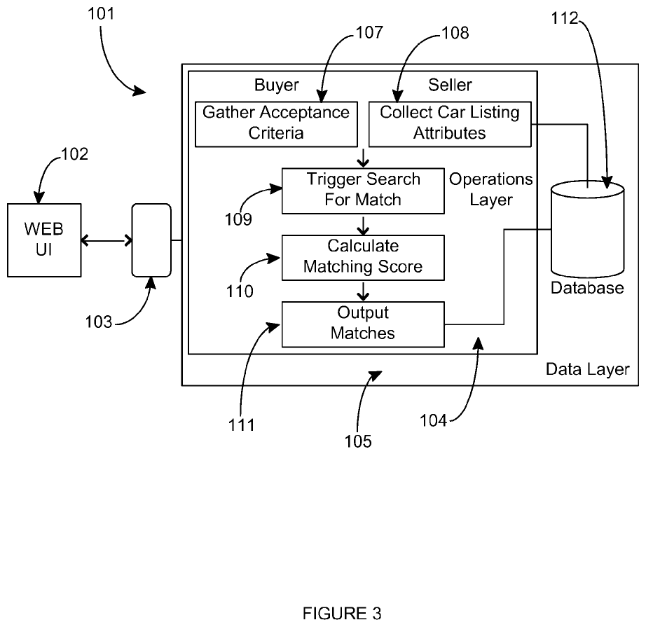

FIG. 3 shows an implementation of an online transaction system 101 according to another embodiment of the invention. In this example the subscriber offering an item for a transaction is described as a seller, the subscriber seeking an item for transaction is described as a buyer and the transaction is a sale transaction.

A GUI 102 is displayed at a subscriber computer 103 which allows a subscriber operator to interact with the system 101. The system 101 is implemented with a data layer 104 and operations layer 105.

The operations layer 105 is configured to perform the following operations. The online transaction system 101 is implemented with an operations layer 104 and a data layer 105. The operations layer 105 is configured by stored computer executable code to provide the following operational modules. The operations layer 105 is configured to perform operations 105 of receiving item data from subscribers. In this example the item data may be validated by module 29 of the system described with reference to FIGS. 1 and 2. The item data received is similar to that uploaded with the embodiment of FIGS. 1 and 2 and carries information on attributes of items offered for transactions.

The operations layer 105 is configured to receive search data. The search data is similar to that of the embodiment of FIGS. 1 and 2 and carries information on criteria and/or attributes of items that a subscriber seeks for a transaction. The operations layer 105 may perform validation operation similar to those described with reference to FIGS. 1 and 2.

The operations layer 105 is also able to run a search 109 for a match between item data and search data by running a database query. In this example the search is performed for each newly received item data or search data in a validation operation that described with reference to FIGS. 1 and 2. In other examples searches may be scheduled. In other examples searches may be performed for selected of stored item data and/or search data.

As shown in FIG. 3 the operational layer 105 is operable to calculate 110 a matching score for item data and/or search data returned by a search and is operable to calculate the matching score dependent on rules for searches. In this example, the matching score is calculated dependent on a data structure similar to that illustrated with reference to FIGS. 1 and 2. In one example given attributes of an item or search criteria may be placed in given places in a hierarchy defined by the data structure with layers of the hierarchy having defined weightings.

FIG. 3 shows the operational layer 105 being operable to output 111 matches from the search 109 that meet searching rules apply to the matching score calculated at the operation 110. In this example the output 111 is saved to a database 112. The same database 112 stores search data received at operation 107 and item data received at operation 108.

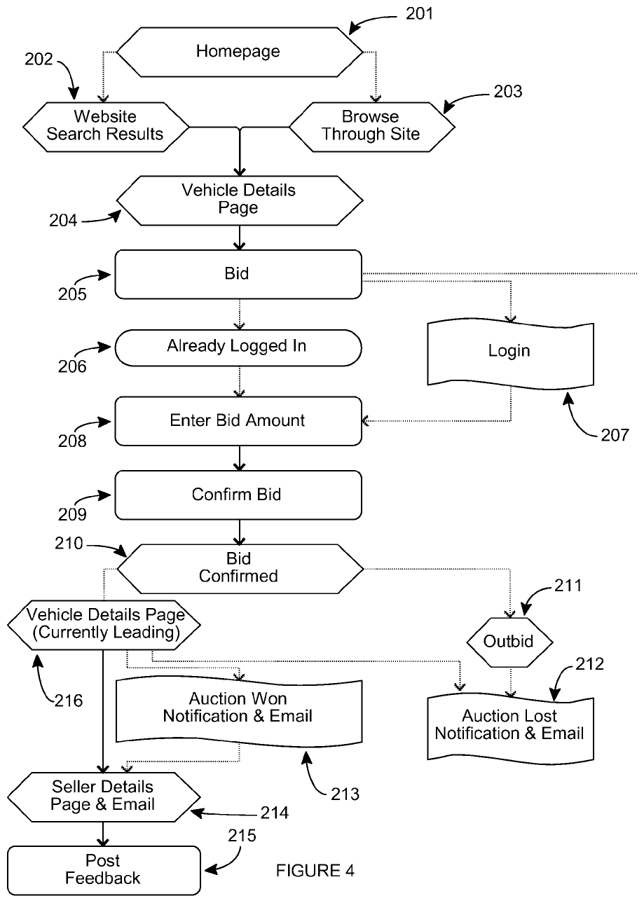

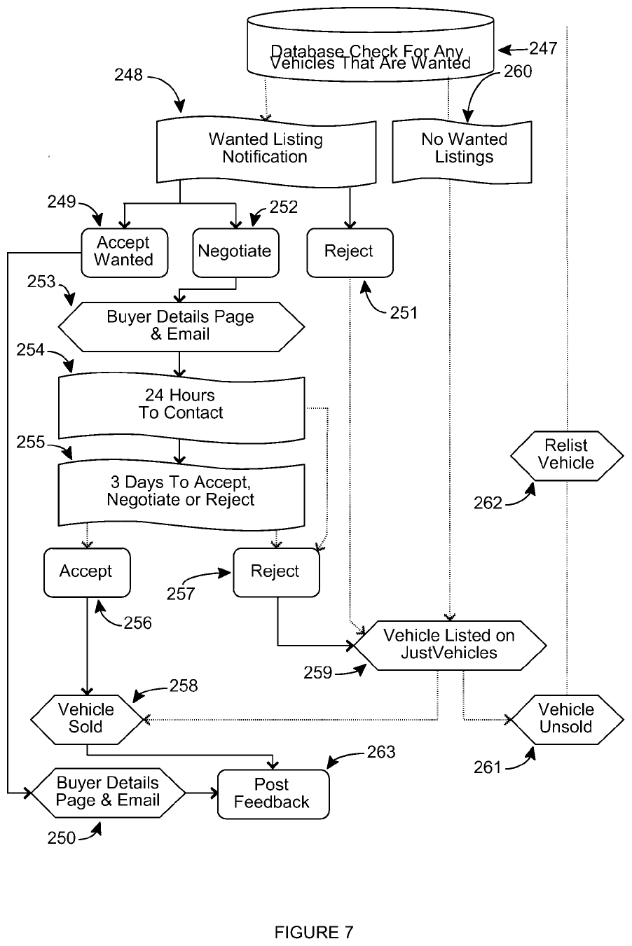

FIGS. 4 to 9 illustrate a use case of and online transaction system according to another embodiment of the invention.

FIG. 4 shows step 201 in which a subscriber views the homepage of a website provided by an online transaction system according to this embodiment of the present invention. The subscriber enters search data at step 202 at GUI controls provided on the web site results returned by query, made using that search data, run on a database which stores item data are displayed at the GUI.

At step 203 the subscriber can, alternatively to entering search data, browse through the website to view publicly presented or listed items that are offered for transaction.

At step 204, whether by displayed results of the query or by a pathway found by browsing the item data, a specific item is selected, or identified, by the subscriber.

At step 205 the system receives bid data, subscriber entered at the GUI, indicating a proposed value for a transaction involving the selected item.

At step 206 the transaction system determines whether the subscriber has logged in and, if so, the transaction-communication data is stored in the database in association with the item. Transaction-communication data carries information which the subscriber intends to be communicated to the subscriber associated with the selected item. In this example the transaction-communication data is bid data which indicates a price which the subscriber is offering to pay in a transaction for the selected item. The reader will understand that a online transaction bidding process has been initiated in this step.

The bid data in this example is available to a subscriber that has entered the item data, to offer the item for transaction for example. The transaction-communication data which is visible to the subscriber entering item data and the subscriber entering the transaction-communication data represents an initiated communication link between the two, in this example, subscribers. At this stage two subscribers selected from a population of subscribers have been connected.

The reader will appreciate that in the process involving step 202, the communication link has been initiated dependent on search data entered by one subscriber and dependent on the query of item data entered by various subscribers and has also been initiated dependent on the entry of the transaction-communication data in response to the displaying of the results of query using the search data.

As an alternative pathway, login is required at step 207 before the bid data can be saved.

At step 209 the bid data is confirmed by the subscriber entering the bid data.

Step 210 the confirmed bid data is compared with any other bid data associated with same item and evaluated against other conditions such as whether a process for entering bids has timed out and the process moves to step 212 with the subscriber entering the confirmed bid data is informed at step that they will not be part of the transaction or the process returns to step 208 where the subscriber can enter new bid data.

In this example, the transaction is the selling and buying of an item and the subscriber associated with the item data may be termed as a seller while the subscriber identified using the data and other data such as timeout data may be termed the buyer. At step 213, if multiple subscribers have entered the data, the online transaction system identifies one buyer from the multiple subscribers.

At step 215 a defined set of subscriber data of the seller is communicated, by email in this example, to a subscriber identified as the buyer by the process at 213.

At step 216 the buyer and seller enter feedback data on the transaction.

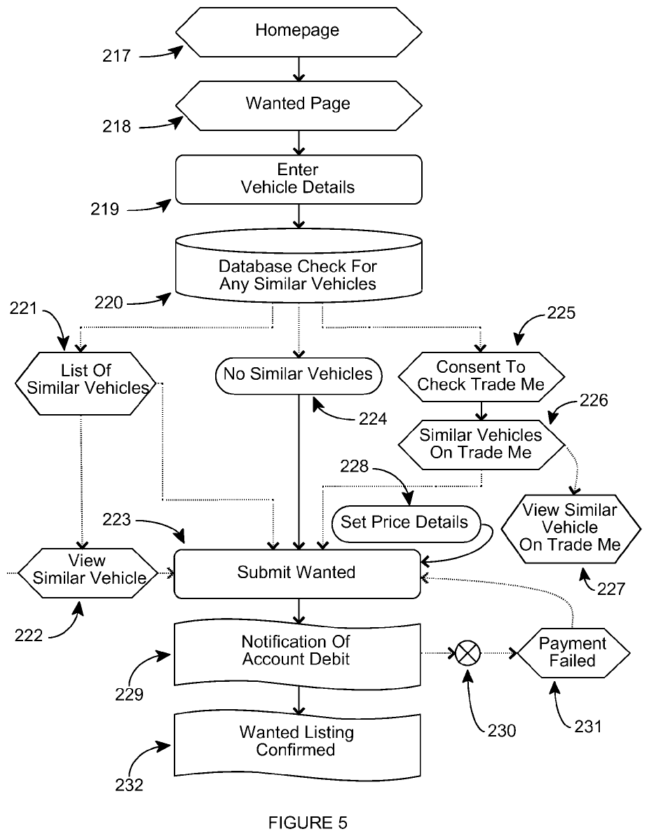

At step 217, shown in FIG. 5, a subscriber seeking and item for a transaction views the homepage of the online transaction system.

At step 218 the same subscriber views a page presenting a GUI which allows subscriber to enter search data.

At step 219 the subscriber enters search data carrying information on attributes of an item sought for a transaction.

At step 220 the online transaction system runs a database query dependent on the search data entered at step 219.

At step 221 a set of item data each carrying information on an item is returned by the search and displayed at the GUI to the subscriber entering search data.

At step 222 the subscriber entering the search data views the item data of items returned by the search, which will typically be items which match the search data with some constraints applied using stored matching rules. In this specific example the purpose of the step is to allow the subscriber to validate that the search data represents a search which is not fulfilled and would represent a valid set of data carrying information on the items the subscriber is seeking. This may be termed a valid “wanted” posting. In other embodiments the purpose of this step may be to gather information at the GUI or from the online transaction system to be stored in association with search data uploaded by the subscriber. This data may be used in database queries or to rank or shortlist results of queries.

At step 223 the subscriber interacts with the GUI to generate data indicating that the search data should be stored by the online transaction system. The stored search data defines database queries for item data. The search data is also available to data base queries defined by item data as new item data is entered which are run, in one example, when new item data is entered but before the item data is stored in a repository that is used to make items publicly available for browsing.

Step 228 the subscriber is able to upload automatic transaction communication data to be associated with the search data. In one example this may be an indication of a value for a transaction. In alternative examples the date entered at 228 may be used as assessment criteria by an automated process within the online transaction system to determine whether the subscriber entering the search data is to complete a transaction. In one example, the data entered at 228 may be used to determine whether the subscriber, if one of a number of subscribers selecting a given item, is to be indicated as the buyer.

At steps 229, 230 and 231 the online transaction system determines whether the subscriber has sufficient funds in an account with the online transaction system to post the search data and facilitates funds if required. The reader will recognise that this step provides validation of the subscriber account. In alternative embodiments other validations of the seeking subscriber may be performed. For example, there may be validations that suitable identification details of the subscriber. Also for example there may be validation by a process, such as a process to determine that the operator is human or that the operator is motivated and/or capable of making a transaction to a given degree or within a given timeframe.

At step 232 the search data is confirmed and saved by the online transaction system at a database which is able to run queries of search data, dependent on item data for example.

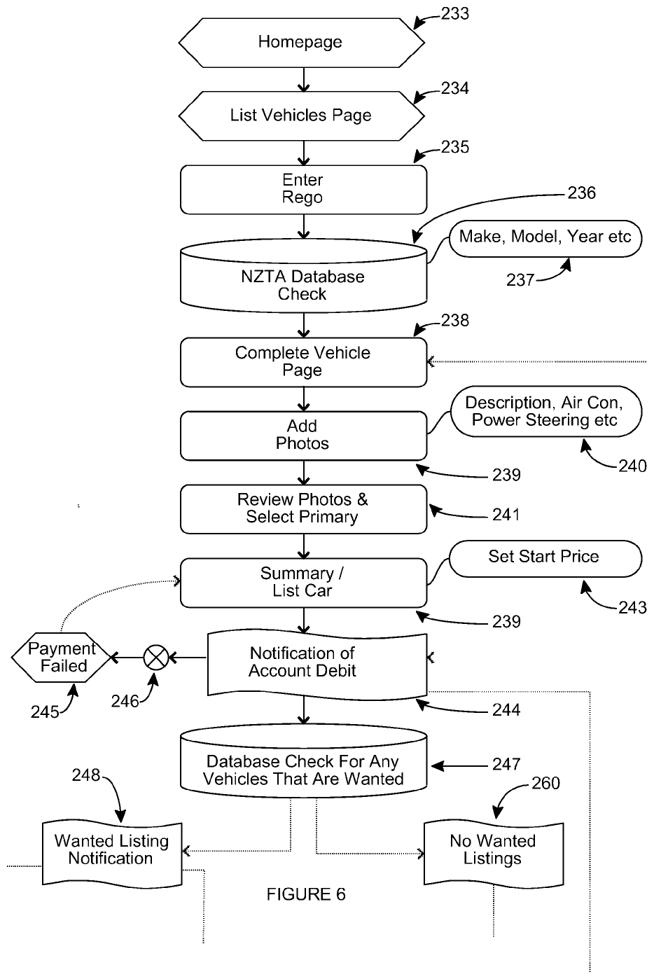

FIG. 6 illustrate a part of the use case for the online transaction system by which a subscriber enters and validates item data. In this example the item is a vehicle.

At step 233 the subscriber entering item data views the webpage GUI of the online transaction system.

At step 224, if no items were returned by the query made dependent on the search data, the subscriber can interact with the GUI to indicate that there search data is nevertheless valid and the search data is saved for use in data base queries.

At step 225 the subscriber interacts with the GUI to indicate that the online transaction system should conduct searches on external databases holding item data. At step 226 the online transaction system parses search data, or a subset, into code or data used for a query run on external database. The external database may be associated with an external online transaction system.

At step 226 the subscriber is the results of the query on the external database are displayed at the GUI for review by the subscriber entering the search data.

At step 234 the subscriber interacts with the GUI to navigate to the page allowing them to enter item data.

At step 235 the subscriber enters some of the item data. In this example the item data is a registration code of a vehicle.

At step 236 the online transaction system parses the registration code and communicates with an external database, a transport agency database in this example, to cause the database to run a query for additional item data.

At step 237 the additional item data is returned from the external database. In this example the additional data carries information on the following attributes the make of the vehicle, and the model of the vehicle the year of registration of the vehicle.

The subscriber interacts with the GUI to check item data returned at step 237 and to correct or confirm item data.

At step 239 the subscriber interacts with the GUI to add further item data form of image data, such as photos.

At step 240 subscriber interacts with the GUI to enter further item data. In this example the further item data may include text provided by the subscriber, such as a textural description of the vehicle.

At step 241 the GUI displays the item data for review by the subscriber.

At step 242 a data structure is used to provide selected attributes carried by the item data for use in database queries and matching operations.

At step 243 the subscriber interacts with the GUI to infer transaction-communication data to be associated with the item data. In this example the transaction-communication data is a start price for a bidding process.

It steps 244, 245 and 246 transaction system checks and facilitates funds for the subscriber's account.

Step 247 the online transaction system parses item data into a query string for a database search for search data, the query string generated dependent on the item data.

Step 248 the subscriber entering the item data is displayed the results of the query. The query may depend on the item data, or a subset of that item data. The subscriber that entered the item data able to interact with the GUI to indicate whether a communication link should be established with a subscriber having entered search data. For example, they may interact with the GUI to indicate whether they accept a “wanted” posting at step 249 and then connected at step 250 to indicate that a transaction has been made. Also, for example, at step 251 they may reject, a “wanted” posting. Also for example, the subscriber entering the item data may indicate that a communication link for the purpose of negotiating the transaction should be established at step 252. The communication link is established at step 253 with transaction-communication data from the subscriber entering item data to be stored and associated with the item data and made accessible to the subscriber having entered the search data identified by the subscriber having entered item data at step 252.

At step 254 a check for a timeout for the communication link is made to reduce processor or data overhead and communication links across the online transaction system. If the timeout is not reached before the subscriber having entered search data contacts the subscriber having entered item data through the online transaction system, then the process moves to step 255 where the subscriber having entered the item data is able to accept the transaction at step 256. Alternatively, the subscriber having entered the search data may reject the transaction and the process returns to step 254. In addition, the process moves to step 259 where the item data is stored by the online transaction system at a database as validated item data. In this example validated indicates that the subscriber has posted the item data after the system has presented relevant search data and to the subscriber has interacted with the GUI to indicate that the item data should be posted. The reader may recognise this indication as a validation control by the subscriber.

In this example it is typical for only one search data entry, indicating one other subscriber seeking an item, is returned.

If it is determined at step 260, after step 247, that no relevant search data was returned by the database query may dependent on the item data then the process would move directly to step 259, with the item data having been validated automatically.

Steps 261 and 262 the online transaction system processes items that are unlikely to be transacted but would otherwise consume processor or data resources.

At step 263 feedback on the transaction is uploaded to the online transaction system.

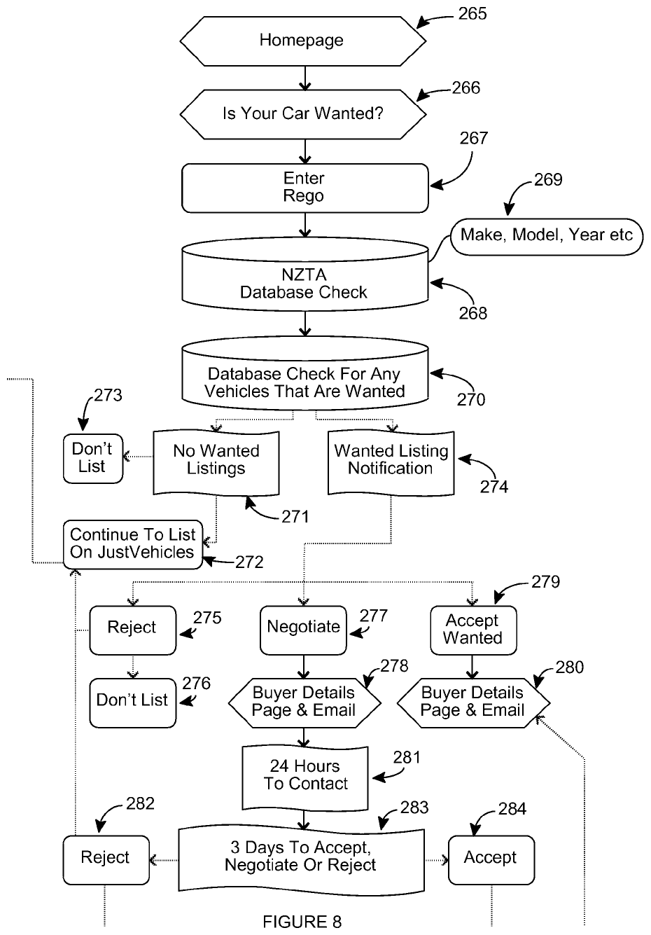

FIG. 8 illustrates an additional process for entering and validating item data which eliminates unnecessary processor or data overhead for the online transaction system.

At steps 265 to 269 a subscriber enters item data similarly to steps described with reference to FIG. 6 and a query is run at step 270 dependent on the item data also similarly to the process of FIG. 6.

If, at step 271 the results of the query indicate no examples of search data indicating subscribers seeking an item with the attributes of the item data the subscriber is able to interact with the GUI at step 272 indicate that the item should be listed nevertheless and the item data is stored. In this example the storage is for listing on the online transaction system. In theiis example the listing is for public display, browsing and searching by subscribers including subscribers that may not have entered validated search data. The reader will appreciate that the subscriber that has entered validated search data has had an opportunity to bid and make a transaction with the subscriber that has entered the item data before the item was listed publicly. The reader will also appreciate that the subscriber that has entered the item data has been in communication for a possible transaction with subscribers of validated searches. These subscribers may have themselves been validated. For example, the subscribers entering the search data may have a paid subscription, a subscription that was established by a qualifying process or by entering given identification data. The subscriptions for search data may be represent a qualified set of operators, such as motivated or trade operators. The subscriber validation may be in addition to the search data having been validated by the operator viewing available items that match their search, or are returned by queries generated dependent on search data, having the opportunity to bid on items and then validating that the search was validated as unfulfilled.

Alternatively, the subscriber may interact with the GUI at step 273 that the item data should not be stored by the online transaction system.

Alternatively, the subscriber may interact with the GUI at step 273 that the item data should not be stored for public viewing and or searching other than by validated search data or by validated searching operators.

If at step 274 a list of search data instances are returned by the query made dependent on the item data the subscriber may interact with the GUI at step 275, after having been displayed the search data, to control the online transaction system to not store the item data. The reader will appreciate that this control has been made after viewing details of the search data which may, for example, indicate that there is a subpopulation of subscribers seeking items have expectations carried in the search data which are unlikely to be met in a transaction in which the subscriber entering the item data is likely to participate.

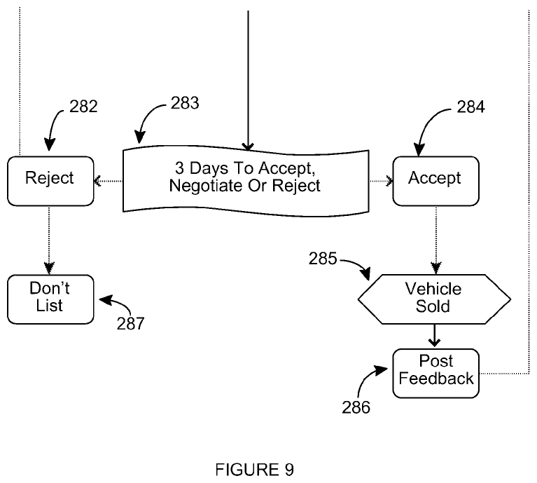

FIG. 9 illustrates follow-on steps of FIG. 8.

In the various alternative embodiments data such as illustrated by 12 in FIG. 1 is substituted by offered item data 7 and search data 8 being included in a database table to indicate their association. In other embodiments pointing data may indicate given offered item data and sought search data to store an association.

In various alternative embodiments to that illustrated with reference to FIG. 2 the posting control 18 add status data to be associated with the search data 7. In various embodiments data may be associated with item data 8.

In various alternative embodiments to that illustrated with reference to FIG. 2 the posting control 18 add time-stamp data to be associated with the search data 7. In various embodiments data may be associated with item data 8.

In various alternative embodiments to that illustrated with reference to FIG. 2 the posting control 18 add data gathered during operations at the GUI 4 to be associated with the search data 7. In various embodiments data may be associated with item data 8.

In various alternative embodiments to that illustrated with reference to FIG. 2 the posting control 18 add data indicating the quality of the search data 7 to be associated with the search data 7. In various embodiments data may be associated with item data 8.

In some embodiments a subscriber is a person that is able to log into the system. In other embodiments a subscriber is an account which may be used by various people. In other embodiments a subscriber is a machine operated by a person. In other embodiments a subscriber is a software agent operated by a person.

The reader will also appreciate that the embodiment of the invention illustrated with reference to FIG. 1 and FIG. 2 is able to operate improved database queries with less processor cost or in the reduced time by making available to queries only data that has been validated after sets of relevant return data has been displayed at a GUI and/or reviewed by subscriber. Other embodiments are able to operate improved database queries by using other data, such as status data, timestamp data or quality data.

In various alternative embodiments to that illustrated with reference to FIG. 3 the embodiment the search data interface is able to perform the operations of the search data validation interface of the embodiment of FIGS. 1 and 2.

In various alternative embodiments to that illustrated with reference to FIG. 3 the embodiment the item data interface is able to perform the operations of the item data validation interface of the embodiment of FIGS. 1 and 2.

Various embodiments alternative to that illustrated with reference to FIG. 3 may use a set of stored search rules to generate a score for item data and/or search data returned by queries. In some embodiments the search rules are used as an alternative to places in a hierarchy defined by the data structure. In some embodiments the search rules may be used in addition to places in a hierarchy defined by the data structure.

In a further embodiment searches such as illustrated with reference to search operation 108 involve parsing item data or search data to queries which conform to queries supported by databases of external systems such as, for example, another online transaction system or, for example, online advertising or posting systems.

The reader will appreciate that embodiments of the invention run database queries for items offered and/or items sought which has been validated after display for a subscriber which has been stored for access by queries with data entered in response to GUI interactions and that these enable a variety of database search queries with various technical advantages.

In various additional embodiments the stored item data is used to generate displays for the items represented by the item data. When item data is entered and prior to storing for public display, a database query is run to return instances of search data which may represent items sought for a transaction. A communication link providing a bidding and transaction process allows subscribers which have entered search data to bid on and buy items before they are publicly listed. Subscribers entering data which is used to run queries for instances of search data prior to saving for publication are connected by bidding or other communication to subscribers that are seeking similar items and have entered validated search data and/or have a validated subscription. This allows sellers, for example, an opportunity to transact the items without fielding interactions from the broader population of buyers that may not have validated their search for items. This may result in a lesser overhead of transaction processing for the seller and the transaction system.

In various embodiments an online transaction system is implemented as a software system.

In various embodiments an online transaction system is implemented as a service provided by software system.

In various embodiments an online transaction system is implemented as Software as a Service (SaaS). The reader will appreciate that the use of the data structures and running queries allows sets of item data or search data to be displayed to subscribers to be matched to attention or time constraints of the subscribers. For example, some embodiments download shortlisted item data or search data dependent on a hierarchical data structure and similarly hierarchical query or shortlisting process.

Various additional embodiments may have operational modules configured by stored computer implementable code with modules equivalent to those described above combined or divided according to alternative implementations. Therefore, the reader will appreciate that the modules and operations described herein are for the purpose of illustrating the configuration and/or operation of embodiments of the invention and the invention is not limited to the configuration and/or modules described.

In the preceding description and the following claims the determiner “a” used in respect of a subject is not intended to be limiting by excluding another of subject or any number of additional of the subject.

In the preceding description and the following claims the word “comprise”, or equivalent variations thereof, is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1-13. (canceled)

14. A process carried out by an online system to provide a communication link between subscriber accounts to allow the accounts to make transactions for items, the process comprising the steps of:
receiving from a first subscriber account item data carrying information on attributes of an item offered for transaction;
running a first database query using a search string generated dependent on said item data, wherein the first database query is run on a database which stores instances of search data carrying information on attributes of a respective item sought for transaction by a second subscriber account,
displaying the results of the first database query at the first subscriber account to allow an operator of the first subscriber account to view any instances of search data returned by the first data base query,
receiving a control input from the first subscriber indicating that the item data is validated in response to an operator viewing the results of the first database query to allow an operator of the first subscriber account to validate the item data;
storing the item data with an indication of validation as an instance of validated item data; and
initiating a communication link between a first subscriber account having entered item data used to generate the database query and a second subscriber account having provided search data returned by the first database query; and
running a second database query on a database which stores said instances of validated item data, the second database query using a string generated dependent on search data received from a third subscriber account, transmitting the item data returned by the second database query for display via the third subscriber account, and receiving a control input from a subscriber linked to the search data indicating that the search data received from the third subscriber account is validated,
wherein the step of storing item data with an indication of validity is subsequent to said initiation of communication between a first subscriber and a second subscriber account.

15. The process of claim 14 wherein the first database query is run in response to item data being received.

16. The process of claim 15 wherein the step of storing item data with an indication of validity is subsequent to said initiation of communication between a first subscriber and a second subscriber account so that the indication validity indicates the data is stored after the first subscriber has had an opportunity to communicate with any second subscriber having entered search data returned by the database query.

17. The process of claim 16, wherein the communication link carries bid data entered by the second subscriber wherein the bid data carries information on a bid made by the second subscriber for a transaction.

18. The process of claim 14 comprising a step of storing search data with an indication of validity subsequent to running the second database query and subsequent to receiving control input from the second so as to provide stored, validated search data.

19. An online system operable to provide a communication link between subscriber accounts to make transactions for items:
the system operable to receive from a first subscriber account item data carrying information on attributes of an item;
the system operable to store item data carrying information on attributes on given items; and
the system operable to receive from a second subscriber account search data carrying information on attributes of items sought, and
the system further operable to run database queries dependent on the search data received to identify and return a list of items dependent on said attributes; and
the system operable to transmit for display at the first subscriber account transaction-communication data carrying information to be communicated from the second subscriber account to the first subscriber account,
the system further operable to store search data subsequent to running a database query dependent on the search data, identifying a list of items returned by the database query, to transmitting for display the items returned by the database query, and to receiving control input from a subscriber linked to the search data indicating that the search data is valid so as to provide search data stored with a status of valid.

20. The system of claim 19 wherein transaction-communication data is bid data which indicates a price which the second subscriber is offering to pay in a transaction for an item indicated by item data.

21. The system of claim 20, wherein the bid data is included in search data received to allow the bid data to be transmitted in response to any item data being returned by the database query.

22. The system of claim 19 further operable to store search data subsequent to running a database query dependent on the search data, identifying a list of items returned by the database query, to transmitting for display the items returned by the database query, and to a receiving control input from a subscriber linked to the search data indicating that the search data is valid so as to provide search data stored with data received by the control input indicating how recent the search data was entered.
